(19) United States
(12) Patent Application Publication
(10) Pub. No.: US 2013/0271761 A1
(43) Pub. Date: Oct. 17, 2013

(54) LASER INDUCED BREAKDOWN SPECTROSCOPY ANALYSER

(71) Applicants: Michael Rutberg, Somerville, MA (US); Paolo Moreschini, Ewing, NJ (US)

(72) Inventors: Michael Rutberg, Somerville, MA (US); Paolo Moreschini, Ewing, NJ (US)

(73) Assignee: TECHNOLOGICAL RESOURCES PTY. LIMITED, Melbourne, Victoria (AU)

(21) Appl. No.: 13/876,765

(22) PCT Filed: Sep. 15, 2011
(86) PCT No.: PCT/AU11/01192

§ 371 Date: Jul. 3, 2013

Related U.S. Application Data
(60) Provisional application No. 61/388,722, filed on Oct. 1, 2010.

(51) Int. Cl. G01N 21/63

(52) U.S. Cl. CPC G01N 21/63
USPC 356/318

(57) ABSTRACT

A laser induced breakdown spectroscopy (LIBS) analyser (10) comprises an optical path P (shown by dashed lines P1 and dash-dot lines P2) and an automatic focus (or tracking) system (12). The optical path P focuses a laser beam emitted from a laser (14) onto a portion of sample S which is to be analysed by the analyser (10), and focuses radiation emitted by the sample S when irradiated by the laser beam to a detector (16). The automatic focus system (12) is capable of varying a length of the optical path P to maintain a constant spatial relationship (i.e. distance) between a focal point (18) of the laser beam and the sample S; as well as maintaining a constant instantaneous field of view (IFOV) of the detector (16) on the focal point of the laser.

### FIELD OF THE INVENTION

The present invention relates to a laser induced breakdown spectroscopy (LIBS) analyser.

### BACKGROUND OF THE INVENTION

Laser induced breakdown spectroscopy (LIBS) is one method of determining the composition of a sample under test. LIBS uses a high energy laser pulse to create a plasma on the surface of the sample. The plasma contains a mixture of excited atoms representative of the elemental composition of the sample. The atoms in the plasma emit photons at wavelengths that are characteristic of each element. A portion of the emitted light is collected and passed to a spectrometer which provides an analysis of the spectrum of the emitted light in terms of intensity against wavelength. The resulting spectrum is indicative of the elemental composition of the sample.

### SUMMARY OF THE INVENTION

In one aspect the invention provides a laser induced breakdown spectroscopy (LIBS) analyser comprising:
an optical path configured to focus a laser beam onto a portion of a sample and to subsequently focus radiation emitted by the portion of the sample in response to irradiation by the laser onto a detector;
an automatic focus system configured to vary a length of the optical path to maintain a focal point of the laser on the portion of the sample whilst simultaneously maintaining a substantially constant instantaneous field of view (IFOV) of the detector on the focal point of the laser; and
a conveyor configured for conveying sequential portions of the sample past the focal point of the laser beam.

The optical path may comprise a transmit path which focuses a laser beam onto the sample, and a receive path which focuses emitted radiation from the sample to a detector; and wherein the automatic focus system varies a length of at least the receive path.

The optical path may comprise a plurality of movable optical elements in a fixed spatial relationship with each other; and wherein the automatic focus system is operable to move the plurality of movable optical elements towards or away from the sample while maintaining their fixed spatial relationship.

The LIBS analyser may comprise a movable support on which the plurality of movable optical elements is mounted and wherein the automatic focus system comprises an actuator operable to move the support to vary the optical path length.

One of the movable optical elements may comprise a focussing lens capable of focussing the laser beam at a focal point on or near a surface of the sample.

The plurality of movable optical elements may comprise a set of one or more of receiving optical elements which are disposed in the receive path wherein each of the receiving optical elements is solely reflective.

The plurality of optical elements may comprise a partial mirror disposed in both the transmit path and the receive path, the partial mirror capable of reflecting a laser beam and transmitting the emitted radiation.

The partial mirror may be a dichroic mirror.

The LIBS analyser may comprise an optical fibre having one end positioned in the optical path to receive the emitted radiation, the optical fibre having an instantaneous field of view of the portion of the sample irradiated by the laser beam; wherein the optical fibre transmits the emitted radiation to a detector and wherein the instantaneous field of view of the detector is the instantaneous field of view of the optical fibre.

In one embodiment the one end of the optical fibre is capable of moving in a fixed spaced relationship with the plurality of moveable optical elements.

In this embodiment the one end of the optical fibre is attached to the support.

In an alternate embodiment the one end of the optical fibre is fixed in one location relative to the moveable optical elements to enable a variation in spatial relationship between the one end and the moveable optical elements. In this embodiment the optical path comprises a focussing mirror in fixed spatial relationship to the one end of the optical fibre, the focussing mirror being capable of focussing the emitted radiation onto the one end of the optical fibre.

In some embodiments of the LIBS analyser the moveable optical elements may comprise:
a pierced mirror and a first mirror arranged wherein the emitted radiation is reflected by the pierced mirror onto the first mirror which directs the emitted radiation to enable receipt by a detector, and wherein the laser beam passes through an opening in the pierced mirror.

In other embodiments of the LIBS analyser the movable optical elements may comprise a full partial mirror and a first mirror wherein the emitted radiation is transmitted through the partial mirror to the first mirror where the emitted radiation is reflected to enable receipt by a detector, and wherein the laser beam is reflected by the full partial mirror toward the sample.

In yet further embodiments of the LIBS the moveable optical elements may comprise a pierced partial mirror and a first mirror wherein the emitted radiation is transmitted through the pierced partial mirror onto the first mirror and reflected by the first mirror to enable receipt thereof by a detector, and wherein the laser beam is reflected by pierced partial mirror toward the sample. In this embodiment the plurality of movable optical elements further comprises a focussing lens and a diverging lens sequentially upstream of the pierced partial mirror with respect to a direction of travel of the laser beam toward the sample. In this embodiment

In some or all embodiments the focussing lens may comprise a micro lens array wherein each micro lens in the array focuses a portion of the laser beam onto respective focal points which are spaced from each other and lie in a common plane.

The LIBS analyser comprises a laser for emitting the laser beam and may comprise a controller capable of controlling the laser to emit the laser at one of a range of pulse rates.

The range of pulse rates may be from 0.1 to 30 Hz.

Alternately the range of pulse rates may be 10 to 20 Hz.

The LIBS analyser may comprise a detector in the form of a spectrometer capable of measuring properties of the emitted radiation and producing a spectrograph providing data relating to the elemental composition of the sample on the basis of the received emitted radiation.

The spectrometer may be operable to integrate emitted radiation generated from a plurality of pulses of the laser beam to produce an integrated spectral analysis of the sample at a read out rate up to the pulse rate.

The LIBS analyser may comprise a gas purging tube, the tube provided with an axial passage through which the laser beam passes to strike the sample.

The gas purging tube may comprise an inlet intermediate of its length through which an inert gas is injected into the passage.

The gas purging tube may reduce in inner diameter from a first maximum diameter at an end of the tube distant the sample to a neck point intermediate a length of the passage and subsequently increases in inner diameter in a direction toward an opposite end of the tube near the sample.

The LIBS analyser may comprise a protective mirror extending across an upstream end of the gas purging tube with respect to a direction of travel of the laser beam wherein the protective window lies in a plane that extends obliquely relative to a direction of travel of the laser beam through the protective window.

In a second aspect the invention provides a system for obtaining an assay of a mineral body comprising:
a machine for extracting samples of the mineral body at different depths of the mineral body at one or more different locations;
a conveyor onto which the samples are deposited, the conveyor capable of transporting the samples in order of depth extraction from the mineral body to a LIBS analyser according the first aspect wherein the automatic focus system automatically focuses the laser beam on the sample conveyed past the analyser on the conveyor belt.

In a third aspect of the invention there is provides a system for obtaining an assay of a mineral body comprising:
a machine for extracting samples of the mineral body at different depths of the mineral body at one or more different locations;
a conveyor onto which the samples are deposited in order of depth extraction from the mineral body;
a LIBS analyser having a laser source which emits a laser beam and a detector for detecting radiation generated by the laser beam striking a mineral sample;
the conveyor arranged to convey the samples to past the analyser at a location where the laser beam strikes the sample;
the analyser being capable of automatically maintaining a constant spatial relationship between a focal point of the laser and the sample, and a constant IFOV for the detector as the conveyor conveys the sample past the laser beam.

The machine for extracting samples may comprise a drill wherein the samples are samples of cutting produced by the drill as it drills into the mineral body.

The may be automated wherein upon operation of the machine to extract the samples the samples are automatically deposited onto the conveyor which automatically conveys the samples past the analyser which in turn automatically analyses the sample.

### BRIEF DESCRIPTION OF THE DRAWINGS

Embodiments of the present invention will now be described by way of example only with reference to the accompanying drawings in which:

FIG. 1 is a schematic representation of an embodiment of a laser induced breakdown spectroscopy analyser in accordance with the present invention;

FIG. 2 is a schematic representation illustrating a mode of operation of the analyser shown in FIG. 1;

FIG. 3 is a schematic representation of a gas purging tube incorporated in the analyser;

FIG. 4 is a schematic representation of an arrangement of optical elements in a second embodiment of the analyser;

FIG. 5 is a schematic representation of an arrangement of optical elements in a third embodiment of the analyser;

FIG. 6 is a schematic representation of an arrangement of optical elements in a fourth embodiment of the analyser;

FIG. 7 is a schematic representation of a focusing lens incorporated in a further embodiment of the analyser; and,

FIG. 8 is a representation one possible application of the analyser on a mobile drill rig.

### DETAILED DESCRIPTION OF PREFERRED EMBODIMENTS

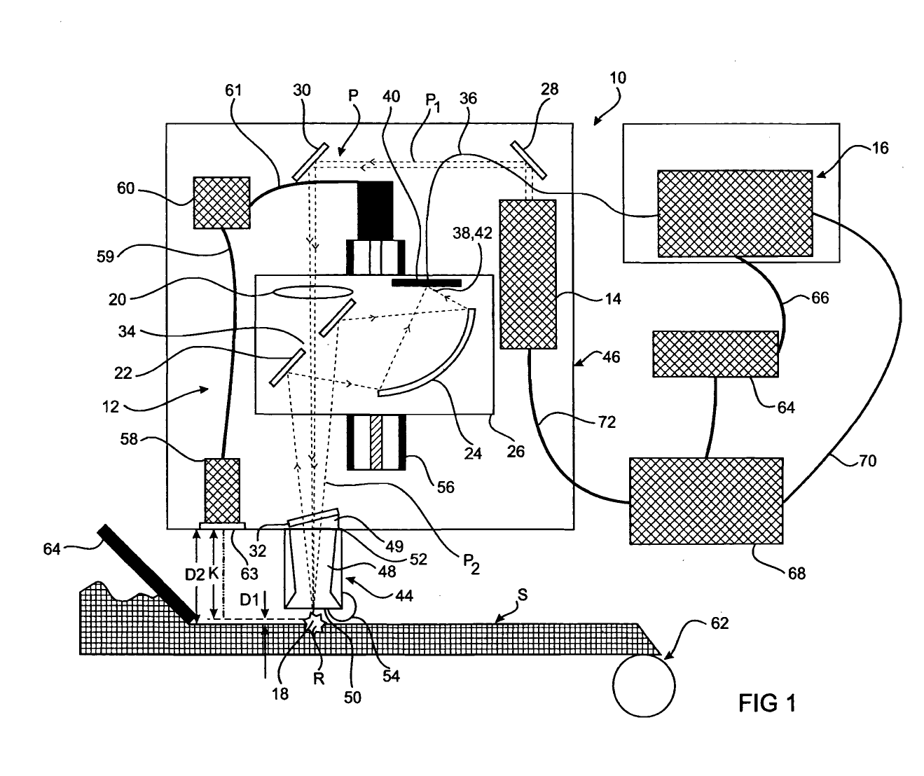

With reference to the accompanying drawings and, in particular FIG. 1, an embodiment of a laser induced breakdown spectroscopy (LIBS) analyser 10 comprises an optical path P (shown by dashed lines P1 and dash-dot lines P2) and an automatic focus (or tracking) system 12. The optical path focuses a laser beam emitted from a laser 14 onto a portion of sample S which is to be analysed by the analyser 10, and focuses radiation emitted by the sample S when irradiated by the laser beam to a detector 16. The automatic focus system 12 is capable of varying a length of the optical path P to maintain a constant spatial relationship (i.e. distance) between a focal point 18 of the laser beam and the sample S; as well as maintaining a constant instantaneous field of view (IFOV) of the detector 16 on the focal point of the laser. The IFOV is generally the angle through which a detector is able to receive electromagnetic radiation and is often expressed as a function of a surface area of the sample visible by the detector at any one time. The IFOV is typically dependent on a distance of the detector from the sample and an angle of radiation received by the detector. When expressed in degrees or radians, the IFOV is the smallest plane angle over which the detector is sensitive to radiation. When expressed in linear or area units such as meters or hectares, the IFOV is an altitude dependent measure of the spatial resolution of the scanner.

The optical path P comprises a plurality of movable optical elements. The portion P1 of the optical path P may be considered to be the transmit path which directs a laser beam from the laser source 14 to the focal point 18 and subsequently onto the sample S. The portion P2 of the optical path P may be considered as a receive path which directs the emitted radiation from the sample S to the detector 16. As explained in greater detail below, at least one of the movable optical elements is in the transmit path P1 and at least one of the optical elements is in the receive path P2. In some embodiments, at least one of the optical elements may be in both the transmit path P1 and the receive path P2. In addition, the optical path may comprise one or more fixed or stationary optical elements.

The automatic focus system 12 is operable to move the movable optical elements so as to maintain the spatial relationship between the focal point 18 and a surface of the sample S as well as maintaining a constant instantaneous field of view of the detector 16.

In FIG. 1, the movable optical elements comprise a focussing lens 20, a pierced mirror 22 and a parabolic mirror 24. Each of these movable optical elements is mounted on a support in the form of a movable base plate 26. The stationary or fixed optical elements in the optical path P comprise a first relay mirror 28, a second relay mirror 30 and a window 32. The first and second relay mirrors 28, 30, and the focussing lens 20 are each in the transmit path P1. The pierced mirror 22 and parabolic mirror 24 are in the receive path P2. The window 32 is in both the transmit path P1 and the receive path P2.

More specifically, the relay mirror 28 is positioned as the first optical element in the optical path P from the laser 14. The mirror 28 reflects a laser beam emitted from the laser 14 through 90° to the second relay mirror 30. The mirror 30 reflects the laser beam through a further 90° and through the focussing lens 20. The laser beam then passes through an aperture 34 formed in the pierced mirror 22 and through the window 32 to focus at the focal point 18 which is positioned at a distance D1 relative to a surface of the sample S. When D1=0 the focal point is on the surface of the sample S, when D1>0 the focal point is above the surface of the sample, and when D1<0 the focal point is below the surface (but still within the body) of the sample S.

The laser beam when striking the sample S generates plasma. Radiation R (i.e. light) from the plasma is emitted in all directions with a portion travelling along the receive path P2 where it passes through the window 32 and subsequently impinges on and reflects from the pierced mirror 22 onto the parabolic mirror 24.

A strain relieved optical fibre 36 provides an optical path for the emitted radiation to the analyser 16. In this particular embodiment, the optical fibre 36 has one end 38 that is fixed by a mounting bracket 40 on the base plate 26 at a focal point 42 of the parabolic mirror 24. Thus the emitted light from the plasma is reflected by the parabolic mirror 24 to the end 38 of the optical fibre 36. As the end 38 is mounted on the base plate 26 there is a fixed spatial relationship between the end 38 of the optical fibre 36 and the other movable optical elements on the plate 26.

The optical elements, base plate 26 and laser 14 are held in an enclosure or housing 46. The housing is formed with a recess 49 which is sealed at its upper end by the window 32. The upper end of the recess 49, and thus the window 32 are inclined so as to lie in a plane which is oblique to the direction of passage of the laser beam. The inclination of the window 32 ensures that any reflection of the laser beam is directed away from the transmit path P1 so that the reflection cannot be reflected back to the laser 14.

A gas purging tube 44 extends from the housing 46 and more particularly depends from the recess 49. The gas purging tube 44 is provided with an axial passage 48 through which the optical path P extends. A first end 50 of the tube 44 is proximal the sample S and the focal point 18, and a second end 52 is distant the sample S and adjacent the housing 46. The protective window 32 extends across the second end 52 providing a physical barrier for dust or other particles entering the housing 46.

As explained in greater detail below, a gas is pumped into the gas purging tube 44 to prevent fouling of the window 32 from particles arising from the sample S. The gas may include, but is not limited to: compressed air, or an inert gas such as argon. A vacuum aspirator 54 operates to draw dust and particles of the sample S away from the optical path P thereby reducing the proportion of laser energy that couples into the dust.

The base plate 26 is mounted on a linear actuator 56 which is operable to move the base plate 26 along a longitudinal axis of the actuator 56. This axis is parallel to the portion of the transmit path P1 from mirror 30 through focusing lens 20 and to the sample S. The linear actuator 56 moves the base plate 26 and thus the movable optical elements in order to maintain the constant spatial relationship (i.e. distance D1) between the focal point 18 and a surface of the sample S. This is achieved by use of a position sensor 58 which communicate via a communication link 59 with an actuator controller and drive mechanism 60 which in turn is coupled by a power and motor feedback link 61 to the actuator 56. A protective window 63 extends across an end of the sensor 58. The position sensor 58 measures a distance D2 between the position sensor 58 and a surface of the sample S. There is a known constant vertical distance or offset K between the sensor 58 and the focal point 18. Variations in the surface level of the sample S result in variations in the distance D2 measured by the sensor 58. Upon sensing a variation in a distance D2 a sensor 58 signals the controller and drive mechanism 60 to operate the linear actuator to linearly move the movable optics either up or down to maintain a constant distance D1 (which may be positive, negative or zero) between the focal point 18 and the surface of the sample S for the point in time when a measurement point under the sensor 58 lies directly beneath the focal point 18. The IFOV of the detector 16 which is the same as the IFOV of the optical fibre 36 also remains constant notwithstanding motion of the movable optics and base plate 26 because the focal point 42 of the optical elements in the receive path is always maintained on the end 38 of the optical fibre 36.

The provision of the automatic focus system 12 facilitates the constant spatial relationship between the focal point 18 and the sample S while also maintaining a constant IFOV for the detector 16. This in turn enables the described embodiment of the analyser 10 to be used in a continuous sampling mode where a sample S is transported across the laser beam for example by way of a conveyor belt 62. This is particularly useful where the composition of the sample S is variable. One example of this is in the assaying of ore. More particularly, in one application of the apparatus 10, ore extracted from different depths of a hole can be passed across the laser beam by the conveyor 62 to enable assaying of the ore as a function of depth of the hole from which the ore is extracted.

In the embodiment illustrated in FIG. 1, a plate or blade 64 is supported above an upper run of the conveyor 62 to provide a degree of smoothing or levelling of the sample S prior to irradiation or illumination with the laser beam. The blade 64 provides a first order of levelling or uniformity in the thickness of the sample S. In further embodiments, the blade 64 may be replaced by a smoothing roller (not shown) for levelling of the sample S. The use of such a roller may find particular application in examples where the sample S comprises particulate material of varying dimensions. to prevent gouging of a surface of the sample when larger particulate material impacts the blade 64.

The use of a physical levelling device such as the blade 64 or a roller provides rough control of the distance D1. Fine control of the distance D1 is provided by the automatic focus system 12 and in particular the sensor 58, controller and drive mechanism 60, linear actuator 56 and the base plate 26. In one example, the position sensor 58 may be in the form of one of many off the shelf laser triangulation position sensors such as an Acuity AR 700 series laser distance gauge.

The emitted radiation which travels along the receive path P2 is channelled by the optical fibre 36 to the spectrometer 16. The spectrometer may be in the form of an Echelle spectrometer. The spectrometer is also coupled with a computer 64 via a communication link 66; and to a laser power supply 68 via a communication link 70. The power supply 68 is also coupled to the laser 14 via cooling, power and signal links 72.

A signal acquisition cycle of the spectrometer 16 is triggered by a pulse from the laser power supply 68 which fires in synchrony with the laser 14. Thus every time the laser 14 emits a laser beam, the spectrometer 16 operates to detect the emitted radiation from the plasma generated by the laser pulse impinging on the sample S. The spectrometer 16 generates a spectrum of the radiation in terms of intensity against wavelength. This spectrum is read out to the computer 64 via the communication link 66. However, this read out rate is not necessarily the same as the pulse rate of the laser 14. In one embodiment, the read out rate is slower than the pulse rate. In such an embodiment the spectrometer 16 is configured to integrate a number of captured spectrums to produce an integrated spectrum per unit of time. For example, the laser 14 may be pulsed at a rate of 15 Hz in which case the analyser 16 also captures fifteen spectra per second, one arising from each pulse from the laser 14. However the spectrometer 16 then integrates the fifteen spectra to form one integral spectrum which is then read out to the computer at a rate of 1 Hz.

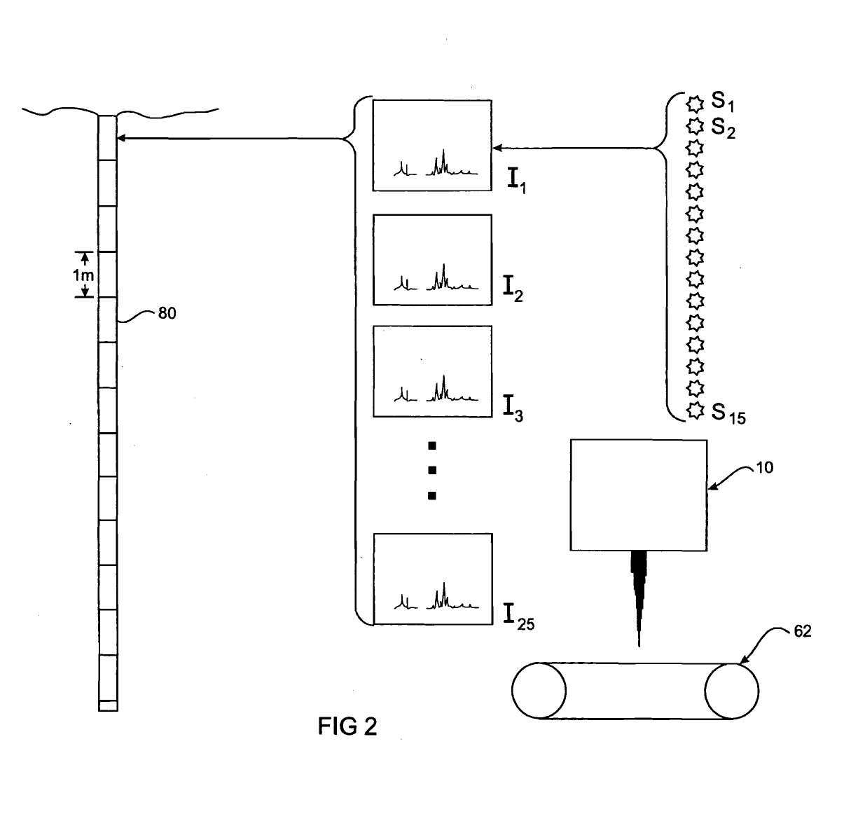

FIG. 2 illustrates an application of the LIBS analyser 10 for the purposes of obtaining the elemental composition of ore extracted from a hole 80. In this example, the hole 80 is a blast hole drilled to a depth of 13.2 m. Each metre of depth of the hole 80 is represented by a horizontal bar. Samples of ore from the hole 10 are fed to the conveyor 62 in order of progressively increasing depth of extraction from the hole 80. In one example, the analyser 10 is operated with the laser 14 having a laser pulse repetition rate of 15 Hz, and the spectrometer 16 having a read out rate of 1 Hz and the hole 80 is drilled at an average drilling rate of 0.04 m/sec. Thus, every second there are fifteen laser pulses from the laser 14 resulting in the spectrometer 16 producing fifteen individual spectra S1-S15, one corresponding to each laser pulse. The fifteen spectra S1-S15 are integrated every second to produce an integrated spectrum I. For an average drilling rate of 0.04 m/sec, there are therefore twenty five integrated spectra I1-I25 for each meter of depth, with each integrated spectrum I being representative of the elemental composition of the ore at a specific depth of the hole 80. In particular, the integrated spectrum or spectra I can be related to a particular depth of the hole 80 by knowledge of the average drilling rate, and speed of travel of the conveyor belt 62.

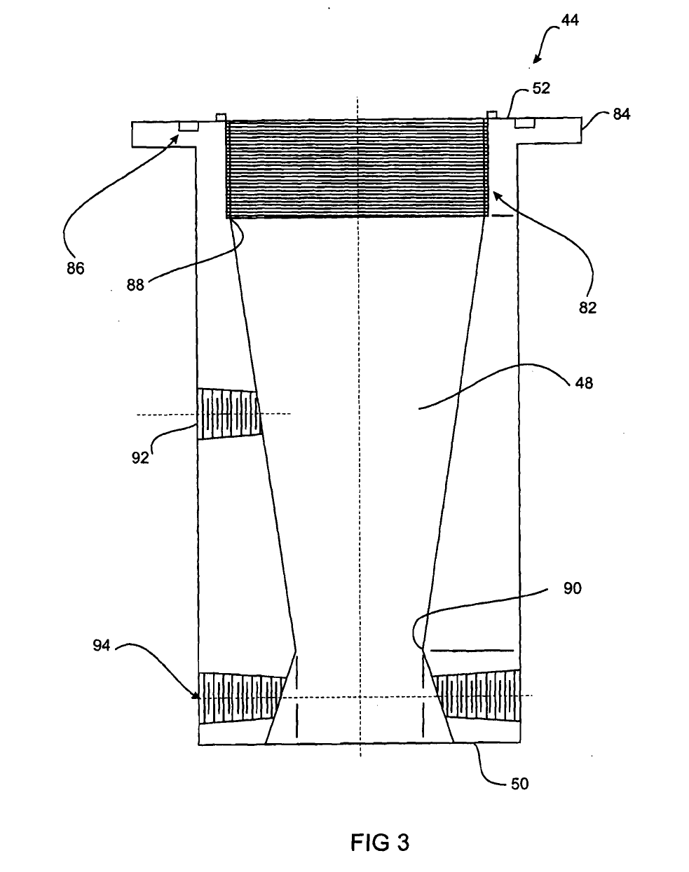

FIG. 3 illustrates in greater detail the gas purging tube 44. An upper most portion of the passage 48 near the end 52 is formed with a thread 82 of constant diameter. This facilitates attachment of the tube 44 to the housing 46. A radially extending flange 84 is provided at the end 52, with a circumferential groove 86 formed in the flange 84 for setting an O-ring to form a seal against the housing 46 and about the recess 49 which communicates with the passage 48. The passage 48 has a maximum diameter at an end closest the end 52 of the tube 44 and coinciding with the termination of the inner end of the thread 82. The diameter of the passage 48 then progressively decreases in a direction toward end 50 to a neck point 90. Thereafter, the inner diameter of the passage 48 progressively increases in a direction toward the end 50. However the diameter at the end 50 is less than the diameter of the passage 48 near the end 52. A radially extending port 92 is formed through the tube 44 intermediate the maximum diameter end of the passage 48 and the necking point 90. The gas is injected into the tube 44 through the port 92. In one example, the gas is injected at a flow rate 55 standard cubic feet per hour (1560 litres per hour). In comparison, the vacuum aspirator (shown in FIG. 1) is provided as a 2.5″ (63.5 mm) diameter articulated tube with a velocity of 3,500 feet/min (17.8 m/s).

In the illustrated embodiment, the tube 44 is also provided with two further ports 94 on either side of the passage 48 between the necking point 90 and the end 50. These ports provide alternate communication points for the vacuum aspirator. However if the vacuum aspirator is external to the gas purging tube 44 shown in FIG. 1, the ports 94 are plugged.

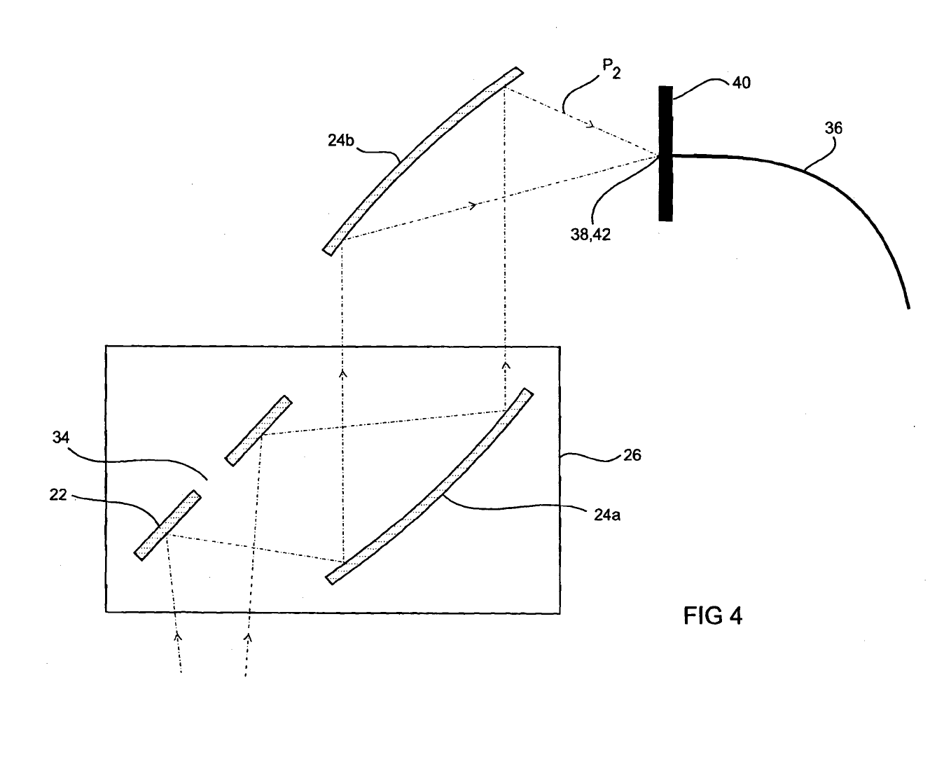

FIGS. 4, 5 and 6 illustrate respective optical element configurations for alternate embodiments of the analyser 10. In FIG. 4, in which only the optical elements in the received path P2 are illustrated, the parabolic mirror 24 of the first embodiment in FIG. 1 is replaced with a collimating parabolic mirror 24a and the focussing parabolic mirror 24b; and the optical fibre mount 40 is now stationary and not fixed to the moving base plate 26. In this embodiment, the emitted radiation is reflected off the pierced mirror 22 onto the culminating parabolic mirror 24a and subsequently reflected to the focussing mirror 24b which in turn focuses the emitted radiation onto the end 38 of the optical fibre 36. The focussing mirror 24b is also stationary and thus in a fixed position relative to the end 38 of the electrical fibre 36. While a distance between the mirrors 24a and 24b can vary by movement of the base plate 26, the emitted radiation is always focused on the end 38. Thus in this embodiment the instantaneous field of view of the detector 16 remains constant notwithstanding motion of the base plate 26.

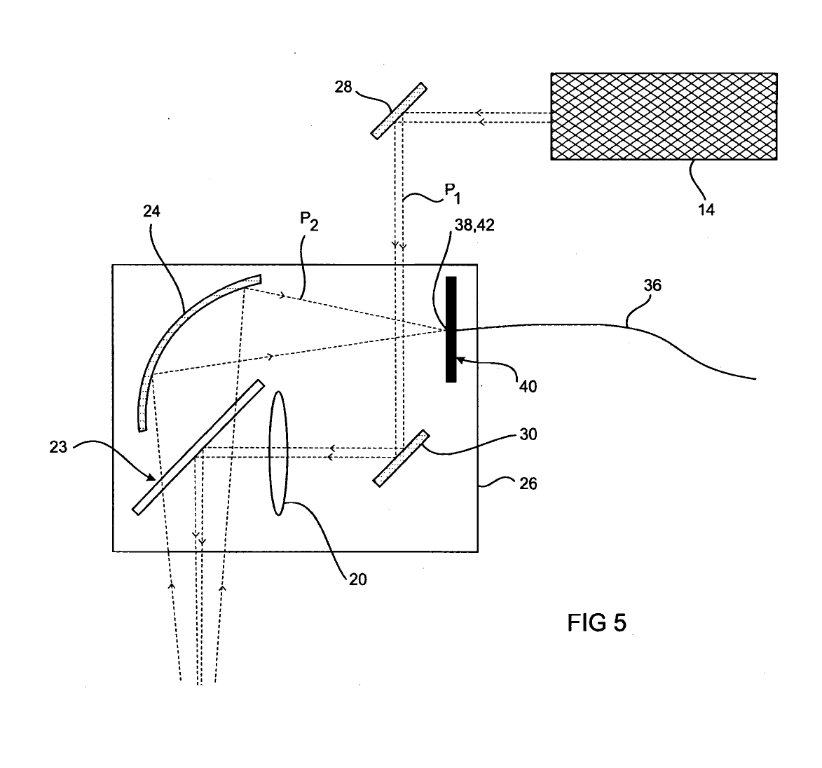

In the embodiment shown in FIG. 5, and in comparison to FIG. 1, the pierced mirror 22 is replaced with a full partial mirror 23, the position of the parabolic mirror 24 and the focusing lens 20 are changed, and the previously stationary mirror 30 now becomes a movable optical element by being mounted on the base plate 26. In this embodiment, the laser beam from the laser 14 is reflected through 90° by the stationary mirror 28 and reflected to the mirror 30 mounted on the base plate 26. This mirror reflects the laser through 90° and to the focussing lens 20 onto the full partial mirror 23 where it is reflect through a further 90° through the focal point. This path constitutes the transmit path P1. The emitted radiation is transmitted through the full partial mirror 23 onto the parabolic mirror 24 where it is reflected and focussed onto the end 38 of the optical fibre 36. The mirror 23 is typically in the form of a dichroic mirror with a very high reflectively at the wave length of the laser, and a very high transitivity across a wavelength sensitive range of the spectrometer 16. In this embodiment, the parabolic mirror 24 is in the receive path P2, while the full partial mirror 23 is an optical element in both the transmit path P1 and the receive path P2.

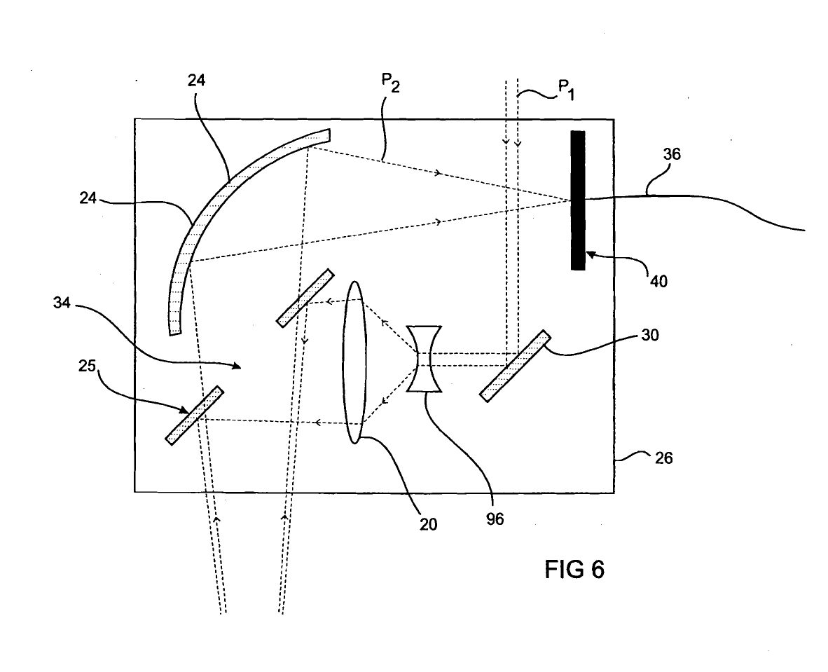

FIG. 6 illustrates an arrangement of optical elements which differs from the embodiment shown in FIG. 1 as follows. The stationary relay mirror 30 of FIG. 1 is now mounted on the moving base plate 26 in the transmit path P1. The pierced mirror 22 is now replaced with a pierced partial mirror 25. The parabolic mirror 24 is moved to be able to reflect emitted radiation passing through the partial mirror 25. In addition the position of the focusing lens 20 has changed on the base plate 26 and a diverging lens 96 has been added in the transmit path P1 between the relay mirror 30 and the focusing lens 20. In this embodiment, the laser beam from the laser is reflected by the relay mirror 30 through the diverging lens 96 and focusing lens 20 to be reflected by the pierced partial mirror 25 to the focal point 18. A portion of the emitted radiation is transmitted through the pierced partial mirror 25 while the remaining portion of the emitted radiation passes through the aperture 34 in the pierced mirror 25. The emitted radiation is subsequently reflected by the mirror 24 onto the end 38 of the optical fibre 36.

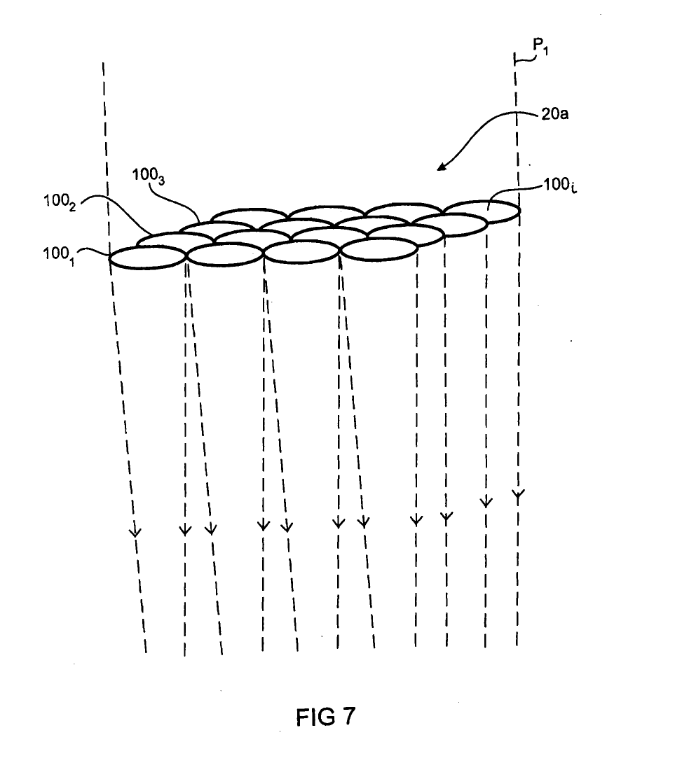

FIG. 7 illustrates a configuration of a focusing lens 20a for yet a further embodiment of the analyser 10. In this embodiment, the focusing lens is in the form of a micro lens array 20a. The micro lens array 20a comprises a plurality of micro lens 100a-100i each of which focuses the laser beam from the laser 14 at respective spaced apart focal points which lie on a common plane. This has the effect of creating a plurality of small plasmas over an increased surface area of a sample S. This in turn creates an emitted radiation that is more representative of the sample S.

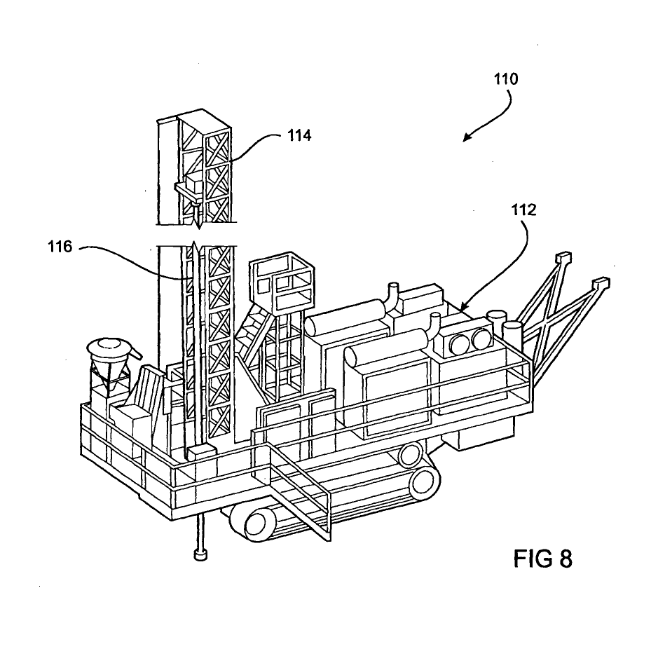

FIG. 8 illustrates an application of the analyser 10 in a system 110 for obtaining an assay of a mineral body. In this specific application the system 110 is associated with a mobile drill rig 112 which can be used for drilling blast holes. The drill rig has a drill tower 114 supporting a drill 116 for drilling holes in a mineral body such a bench of ore. When the dill 116 is operated is produces drill cuttings. The cuttings form mineral samples S which are fed to an analyser 10 associated with the mobile rig 112. This association may be by mounting the analyser at convenient location on the rig, or placing analyser 10 on a separate vehicle which can be driven to the rig 112 or may be towed by the rig 112. In either case a feed system is used to transport the samples S to analyser.

The analyser 10 is operated in the same manner as herein before described to provide an elemental analysis of the sample S and thus produce or facilitate the production of, an assay for the mineral body. When the analyser 10 is operated, the automatic focus system 12 operates to ensure optimum focusing of the laser beam while maintaining a constant IFOV for the detector 16 irrespective of variations in the level or profile of the surface of the sample S which may arise due to the irregular shape of the cutting which constitute the sample S or variations in the volume of sample S being transported to the analyser due to variations in ground type and penetration rate of the drill 116 into the mineral body.

The system 110 is, or can be, automated to the extent that when drilling has commenced the samples S are automatically feed to analyser, with the analyser configured to automatically operate to perform the elemental analysis of the samples S as described above with reference to FIG. 2.

In a variation of the system 110 a machine other than the drill 116 can be used to extract the samples S from the mineral body, such as for example an excavator, an air lift device or an auger. In any form or variation of the system 110, by operating the system for a number of holes it becomes possible to produce a stratified or 3-D assay for the mineral body or part thereof.

Now that embodiments of the analyser have been described in detail it will be apparent to those skilled in the relevant arts that numerous modifications and variations may be made without departing from the basic inventive concepts. For example, the detector 16 is described as being in the form of an Echelle spectrometer. However other types of spectrometers may be used. Further, the embodiment describes a laser pulse rate of 15 Hz and a detector with a rate of 1 Hz. However these rates are merely illustrative and embodiments of the analyser 10 may operate with different rates. For example, the laser pulse rate may be in the range of 0.1 Hz to 30 Hz. Also, the read out rate of the spectrometer 16 may, depending on the nature of the spectrometer 16, be up to the laser pulse rate, for example from marginally greater 0 Hz (for example 0.001 Hz) up to the laser pulse rate. In addition, the parabolic mirror 24 in the illustrated embodiments may be replaced with other types of mirrors such as for example an ellipsoid mirror which provides a tighter focus on the end 38 of the optical fibre 36. In yet a further variation, the energy of the laser at the sample S may be attenuated to minimise dust breakdown events. This attenuation may be achieved by forming one or both of the mirrors 28, 30 to be semi reflective or alternately reducing the energy output of the laser 14 itself. Additionally while the embodiments described each relate to the continuous sampling and analysis, the LIBS analyser 10 can be operated if desired to analyse a static sample. This would simply involve stopping the conveyor 62 and placing a sample in line with the focal point 18.

Many modifications or variations of the above examples will be apparent to those skilled in the art without departing from the scope of the present invention. All such modifications and variations together with others that would be obvious to persons of ordinary skill in the art are deemed to be within the scope of the present invention, the nature of which is to be determined from the above description and the appended claims. Features that are common to the art are not explained in any detail as they are deemed to be easily understood by the skilled person.

Similarly, throughout this specification, the term “comprising” and its grammatical equivalents shall be taken to have a non-exhaustive or open-ended meaning, unless the context of use clearly indicates otherwise. It is further to be appreciated that reference to “one example” or “an example” of the invention is not made in an exclusive sense. Accordingly, one example may exemplify certain aspects of the invention, whilst other aspects are exemplified in a different example. These examples are intended to assist the skilled person in performing the invention and are not intended to limit the overall scope of the invention in any way unless the context clearly indicates otherwise.

1. A laser induced breakdown spectroscopy (LIBS) analyser comprising:
an optical path configured to focus a laser beam onto a portion of a sample and to subsequently focus radiation emitted by the portion of the sample in response to irradiation by the laser onto a detector;
an automatic focus system configured to vary a length of the optical path to maintain a focal point of the laser on the portion of the sample whilst simultaneously maintaining a substantially constant instantaneous field of view (IFOV) of the detector on the focal point of the laser; and
a conveyor configured for conveying sequential portions of the sample past the focal point of the laser beam.

2. The LIBS analyser according to claim 1 wherein the optical path comprises a transmit path which focuses a laser beam onto the sample, and a receive path which focuses emitted radiation from the sample to a detector; and
wherein the automatic focus system varies a length of at least the receive path.

3. The LIBS analyser according to claim 1 or 2 wherein the optical path comprises a plurality of movable optical elements in a fixed spatial relationship with each other; and wherein the automatic focus system is operable to move the plurality of movable optical elements toward or away from the sample while maintaining their fixed spatial relationship.

4. The LIBS analyser according to claim 3 comprising a movable support on which the plurality of movable optical elements is mounted and wherein the automatic focus system comprises an actuator operable to move the support to vary the optical path length.

5. The LIBS analyser according to claim 3 or 4 wherein one of the movable optical elements comprises a focussing lens capable of focussing the laser beam at a focal point on or near a surface of the sample.

6. The LIBS analyser according to any one of claims 3 to 5 wherein the plurality of movable optical elements comprises a set of one or more receiving optical elements which are disposed in the receive path wherein each of the receiving optical elements is solely reflective.

7. The LIBS analyser according to any one of claims 3 to 5 wherein the plurality of optical elements comprises a partial mirror disposed in both the transmit path and the receive path, the partial mirror capable of reflecting a laser beam and transmitting the emitted radiation.

8. The LIBS analyser according to claim 7 wherein the partial mirror is a dichroic mirror.

9. The LIBS analyser according to any one of claims 1 to 8 comprising an optical fibre having one end positioned in the optical path to receive the emitted radiation, the optical fibre having an instantaneous field of view of the portion of the sample irradiated by the laser beam; wherein the optical fibre transmits the emitted radiation to a detector and wherein the instantaneous field of view of the detector is the instantaneous field of view of the optical fibre.

10. The LIBS analyser according to claim 9 wherein the one end of the optical fibre is capable of moving in a fixed spaced relationship with the plurality of moveable optical elements.

11. The LIBS analyser according to claim 10 wherein the one end of the optical fibre is attached to the support.

12. The LIBS analyser according to claim 9 wherein the one end of the optical fibre is fixed in one location relative to the moveable optical elements to enable a variation in spatial relationship between the one end and the moveable optical elements.

13. The LIBS analyser according to claim 12 wherein the optical path comprises a focussing mirror in fixed spatial relationship to the one end of the optical fibre, the focussing mirror being capable of focussing the emitted radiation onto the one end of the optical fibre.

14. The LIBS analyser according to claim 4 wherein the moveable optical elements comprise:
a pierced mirror and a first mirror arranged wherein the emitted radiation is reflected by the pierced mirror onto the first mirror which directs the emitted radiation to enable receipt by a detector, and wherein the laser beam passes through an opening in the pierced mirror.

15. The LIBS analyser according to claim 4 wherein the movable optical elements comprise a full partial mirror and a first mirror wherein the emitted radiation is transmitted through the partial mirror to the first mirror where the emitted radiation is reflected to enable receipt by a detector, and wherein the laser beam is reflected by the full partial mirror toward the sample.

16. The LIBS analyser according to claim 4 wherein the moveable optical elements comprise a pierced partial mirror and a first mirror wherein the emitted radiation is transmitted through the pierced partial mirror onto the first mirror and reflected by the first mirror to enable receipt thereof by a detector, and wherein the laser beam is reflected by pierced partial mirror toward the sample.

17. The LIBS analyser according to claim 16 wherein the plurality of movable optical elements further comprises a focussing lens and a diverging lens sequentially upstream of the pierced partial mirror with respect to a direction of travel of the laser beam toward the sample.

18. The LIBS analyser according to any one of claims 5 to 17 wherein the focussing lens comprises a micro lens array wherein each micro lens in the array focuses a portion of the laser beam onto respective focal points which are spaced from each other and lie in a common plane.

19. The LIBS analyser according to any one of claims 1 to 18 comprising a laser for emitting the laser beam and a controller capable of controlling the laser to emit the laser at one of a range of pulse rates.

20. The LIBS analyser according to claim 19 wherein the range of pulse rates is from 0.1 to 30 Hz.

21. The LIBS analyser according to claim 19 wherein the range of pulse rates is 10 to 20 Hz.

22. The LIBS analyser according to any one of claims 19 to 21 comprising a detector in the form of a spectrometer capable of measuring properties of the emitted radiation and producing a spectrograph providing data relating to the elemental composition of the sample on the basis of the received emitted radiation.

23. The LIBS analyser according to claim 22 wherein the spectrometer is operable to integrate emitted radiation generated from a plurality of pulses of the laser beam to produce an integrated spectral analysis of the sample at a read out rate up to the pulse rate.

24. The LIBS analyser according to any one of claims 1 to 23 comprising a gas purging tube, the tube provided with an axial passage through which the laser beam passes to strike the sample.

25. The LIBS analyser according to claim 24 comprising a protective mirror extending across an upstream end of the gas purging tube with respect to a direction of travel of the laser beam wherein the protective window lies in a plane that extends obliquely relative to a direction of travel of the laser beam through the protective window.

26. A system for obtaining an assay of a mineral body comprising:
a machine for extracting samples of the mineral body at different depths of the mineral body at one or more different locations; and,
a conveyor onto which the samples are deposited, the conveyor capable of transporting the samples in order of depth extraction from the mineral body to a LIBS analyser as claimed in any one of claims 1 to 25 wherein the automatic focus system automatically focuses the laser beam on the sample conveyed past the analyser on the conveyor belt.

27. A system for obtaining an assay of a mineral body comprising:
a machine for extracting samples of the mineral body at different depths of the mineral body at one or more different locations;
a conveyor onto which the samples are deposited in order of depth extraction from the mineral body;
a LIBS analyser having a laser source which emits a laser beam and a detector for detecting radiation generated by the laser beam striking a mineral sample;
the conveyor arranged to convey the samples to past the analyser at a location where the laser beam strikes the sample;
the analyser being capable of automatically maintaining a constant spatial relationship between a focal point of the laser and the sample, and a constant IFOV for the detector as the conveyor conveys the sample past the laser beam.

28. The system according to claim 26 or 27 wherein the machine for extracting samples comprises a drill and the samples are samples of cutting produced by the drill as it drills into the mineral body.

29. The system according to any one of claims 26 to 28 wherein the system is automated wherein upon operation of the machine to extract the samples the samples are automatically deposited onto the conveyor which automatically conveys the samples past the analyser which in turn automatically analyses the sample.
